(19) United States
(12) Patent Application Publication
(10) Pub. No.: US 2016/0362001 A1
(43) Pub. Date: Dec. 15, 2016

(54) METHOD AND APPARATUS FOR RECEIVING MULTIMEDIA DATA OF SURROUNDING CAR BASED ON LOCATION IN WIRELESS COMMUNICATION SYSTEM

(71) Applicant: MtoV Inc., Daejeon (KR)

(72) Inventors: Sangsu Jung, Uiwang-si (KR); Youngsam Kim, Daejeon (KR); Jongwoo Choi, Daejeon (KR)

(21) Appl. No.: 14/953,028

(22) Filed: Nov. 27, 2015

(30) Foreign Application Priority Data
Jun. 9, 2015 (KR) 10-2015-0081196

(51) Int. Cl. B60K 35/00; H04W 4/04; H04L 29/08

(52) U.S. Cl. CPC B60K 35/00; H04L 67/12; H04W 4/046

(57) ABSTRACT

The invention relates to a method and an apparatus for receiving multimedia data of surrounding vehicle based on location in wireless communication system. According to the present invention, the method for receiving multimedia data of at least one surrounding vehicle(s) on the basis of location by an in-vehicle communication apparatus of a vehicle in a wireless communication systems, comprising the steps of: receiving surrounding vehicle signals including information on VID of each of the at least one surrounding vehicle(s) from each in-vehicle communication apparatuses of the at least one surrounding vehicle(s), displaying each of the at least one surrounding vehicle(s) on the basis of the received surrounding vehicle signals, and if a user of the in-vehicle communication apparatus selects a specific vehicle of at least one displayed surrounding vehicle(s), receiving additional information on the specific vehicle and displaying the received additional information on the specific vehicle.

### CROSS-REFERENCE TO RELATED APPLICATION

This application claims priority from Korean Application No. 10-2015-0081196, filed on Jun. 9, 2015 in the Korean Intellectual Property Office. The disclosure of the above patent is incorporated herein by reference in its entirety.

### TECHNICAL FIELD

The invention relates to a method and an apparatus for receiving multimedia data of surrounding vehicle based on location in wireless communication system, in particular wherein the information about the surround vehicle is displayed on the basis of the surrounding vehicle signals received from at least one surround vehicle, and, if a user selects a specific vehicle on the basis of the displayed information about the surrounding vehicle, then the multimedia data for the selected specific vehicle is received from a sever and displayed.

### BACKGROUND ART

As a technology for wireless communication system is recently developed, a research on vehicle safety or driving safety using vehicle communication network is in progress by combining the developed wireless communication system into a vehicle.

More specifically, the vehicle safety or driving safety using the vehicle communication network technology may refer to a technology to help a vehicle driver ensure driving stability and efficiently respond to an emergent situation due to, for example, an external factor by collecting information on any surrounding vehicle or surrounding situation via an in-vehicle communication network and informing the driver of the collection information, in order to proactively prevent the driver from being faced with the emergent situation.

The in-vehicle communication network may be generally categorized into a vehicle internal network and a vehicle external network. A vehicle internal network, also known as IVN (In Vehicle Network), refers to a communication network between sensors, electronic units, or devices in a vehicle, one of those technologies utilized to informing the vehicle user(s) of any emergent situation or faulty area.

In addition, a vehicle external network may be roughly classified into V2I (Vehicle to Infrastructure) and V2V (Vehicle to Vehicle). The V2I means communication network infrastructure technology between a vehicle and its surrounding base station, while the V2V communication network infrastructure technology between one vehicle and other vehicle.

A vehicle can receive traffic information or information on surrounding vehicle(s) from a surrounding base station using the V2I technology. A vehicle can receive the information on its surrounding vehicle(s) directly from its surrounding vehicle(s), or it is also possible to transmit and receive information on any danger detected by each vehicle, using the V2V technology.

The technology utilizing the abovementioned vehicle internal network may be used in the manner of providing the driver with the information through specific displays such as instrument panel or audio system in the vehicle according to its purpose. However, this kind of information may be recognized and provided only for the corresponding vehicle so that it may be difficult to recognize the information on surrounding vehicle(s) located in the front, rear or side of the corresponding vehicle.

Furthermore, in spite of using the vehicle external network (V2I or V2V) it is difficult to exactly recognize the locations of each surrounding vehicle in the situation that a number of surrounding vehicles exist on the road, which accordingly causes difficulty in exactly indentifying the information on each surrounding vehicle.

Therefore, there is currently still a need to share driving information with the surrounding vehicles more exactly and minutely in order to more enhance the driving stability.

### DISCLOSURE OF THE INVENTION

### Technical Task

For the purpose of solving the abovementioned problems, In one technical aspect of the invention, provided herein is an in-vehicle communication apparatus receives multimedia data of surrounding vehicle based on location in wireless communication system.

In another technical aspect of the invention, provided herein is a method for displaying surrounding vehicle information and its location information received from the surrounding vehicle to the driver.

In another technical aspect of the invention, provided herein is a method for displaying the multimedia data received from a server for a specific vehicle selected by the driver among those displayed surrounding vehicles to the driver.

In another technical aspect of the invention, provided herein is an apparatus to perform the methods.

Technical tasks obtainable from the present invention are non-limited by the above-mentioned technical tasks. And, other unmentioned technical tasks can be clearly understood from the following description by those having ordinary skill in the technical field to which the invention pertains.

### Technical Solution

In one technical aspect of the present invention, a method of receiving multimedia data of at least one surrounding vehicle(s) on the basis of location by an in-vehicle communication apparatus of a vehicle in a wireless communication system comprises receiving surrounding vehicle signal(s) including information on VID (Vehicle Identifier) of each of the at least one surrounding vehicle(s) from each in-vehicle communication apparatuses of the at least one surrounding vehicle(s), displaying each of the at least one surrounding vehicle(s) on the basis of the received surrounding vehicle signal(s) and if an user of the in-vehicle communication apparatus selects a specific vehicle of the at least one displayed surrounding vehicle(s), receiving additional information on the specific vehicle from a server and displaying the received additional information on the specific vehicle, wherein the additional information includes at least one of vehicle information and location information of the specific vehicle, and the multimedia data generated by an in-vehicle communication apparatus of the selected specific vehicle.

In another technical aspect of the present invention, the surrounding vehicle(s) is at least one vehicle located within a predetermined distance from the vehicle.

In the respective aspects of the present invention, the location information of the specific vehicle comprises direction and distance of a gap determined based on the vehicle.

In the respective aspects of the present invention, the vehicle information of the specific vehicle includes driving direction, steering angle, vehicle speed, applied or unapplied state of the brake, and status information of the driver of the specific vehicle.

In the respective aspects of the present invention, the information on VID includes at least one of VIN (Vehicle Identification Number) of the surrounding vehicle(s), QR (Quick Response) code, text, and diagram representing the surrounding vehicle(s), and vehicle number indicated on license plate of the surrounding vehicle(s).

In the respective aspects of the present invention, the step of displaying the additional information further comprises transmitting an additional information request message, generated by including a vehicle identification information of the selected specific vehicle, to the server and receiving the additional information, which the server received from the specific vehicle on the basis of the vehicle identification information in the additional information request message as a response to the additional information request message, from the server.

In the respective aspects of the present invention, the multimedia data includes the real-time image information taken by the in-vehicle communication apparatus in the selected specific vehicle and the sound information recorded by the in-vehicle communication apparatus in the selected specific vehicle.

In the respective aspects of the present invention, the step of receiving and displaying the additional information, comprises receiving the additional information by means of streaming method and displaying the received additional information.

In the respective aspects of the present invention, the signals from the surrounding vehicle(s) are received by beacon.

In one technical aspect of the present invention, An in-vehicle communication apparatus of a vehicle for receiving multimedia data of at least one surrounding vehicle(s) on the basis of location in wireless communication system comprises a display unit, a wireless communication unit including transmission unit and reception unit and a control unit configured to connect with the display unit and the wireless communication unit and to control the display unit and the wireless communication unit, wherein the control unit configured to receive surrounding vehicle signal(s) including information on VID (Vehicle Identifier) of each of the at least one surrounding vehicle(s) via the wireless communication unit from each in-vehicle communication apparatuses of the at least one surrounding vehicle(s), wherein the control unit configured to display each of the at least one surrounding vehicle(s) via the display unit on the basis of the received surrounding vehicle signal(s), if an user of the in-vehicle communication apparatus selects a specific vehicle of the at least one displayed surrounding vehicle(s), wherein the control unit configured to receive additional information on the selected specific vehicle from the server via the wireless communication unit and to display the received additional information on the specific vehicle via the display unit and wherein the additional information includes at least one of vehicle information and location information of the specific vehicle, and the multimedia data generated by an in-vehicle communication apparatus in the selected specific vehicle.

### Advantageous Effects

According to the invention, it is possible to achieve the effects as described below. However, the effects capable of being achieved through the invention are not limited to these.

According to the invention, first, a method with which an in-vehicle communication apparatus receives multimedia data of surrounding vehicle based on location in wireless communication system may be provided.

According to the invention, second, a method for displaying surrounding vehicle information and its location information received from the surrounding vehicle to the driver may be provided.

According to the invention, third, a method for displaying the multimedia data received from a server for a specific vehicle selected by the driver among those displayed surrounding vehicles to the driver may be provided.

According to the invention, fourth, an apparatus to perform the methods may be provided.

Effects obtainable from the invention are non-limited by the above mentioned effect. And, other unmentioned effects can be clearly understood from the following description by those having ordinary skill in the technical field to which the invention pertains.

### DESCRIPTION OF DRAWINGS

FIG. 1 is a diagram for one example of a communication environment between a vehicle and surrounding vehicles thereof in wireless communication system to which the invention is applicable.

FIG. 2 is a diagram to shows a flowchart for a method with which an in-vehicle communication apparatus receives multimedia data of surrounding vehicle based on location in wireless communication system according to one embodiment of the invention.

FIG. 3 is a diagram to describe a method with which the in-vehicle communication apparatus receives multimedia data of surrounding vehicle through a server in wireless communication system according to one embodiment of the invention.

FIG. 4 is a block diagram to represent the components of the in-vehicle communication apparatus and the server according to one embodiment of the invention.

### DETAILED DESCRIPTION OF THE EMBODIMENTS

Hereinafter, preferable forms of embodiments according to the invention will be described in detail by referring to the attached drawings. Detailed descriptions to be disclosed hereinafter along with the attached drawings are to explain forms of embodiments of the invention, rather than representing a unique form of embodiment in which the invention may be implemented.

For some cases, known structures and apparatuses may be omitted to avoid any ambiguousness of the concept of the invention, resulting in that a form of block diagram shown for only key functions of each structure and apparatus may be included in a drawing describing the invention. In addition, when describing a component, an identical numeral will be used for an identical component for the sake of convenience of description throughout this specification.

Throughout this specification, when it is described that a certain unit comprises or includes a component, this means the unit may include additional components, rather than excluding other components unless specifically described in an opposite manner.

In addition, a term, “- unit” described in the specification means a unit to process at least one function or action, which may be implemented by hardware, software, or the combination of the two.

Furthermore, “a or an,” “one,” and similar expression may be used to include both of singular and plural numbers in the context describing the invention in this specification, unless otherwise indicated or clearly contradicted by relevant context.

Together, specific terms used in embodiments of the invention are provided to support the understanding of the invention, having the same meanings as those generally understood by a person skilled in the art, including technical or scientific terminologies, unless otherwise defined.

Hereinafter, preferable forms of embodiments according to the invention will be described in detail by referring to the attached drawings. As mentioned above, detailed descriptions to be disclosed hereinafter along with the attached drawings are to explain forms of embodiments of the invention, rather than representing a unique form of embodiment in which the invention may be implemented.

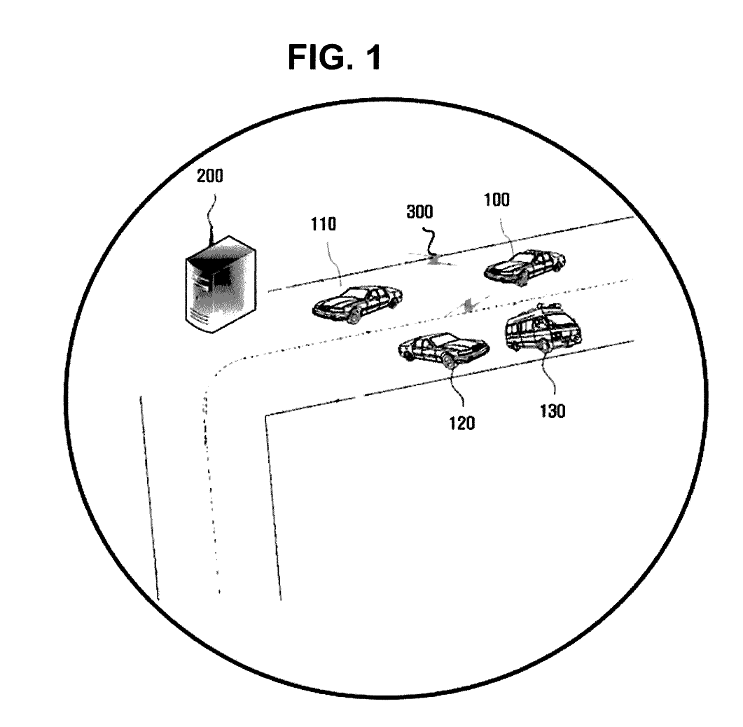

FIG. 1 is a diagram for one example of a communication environment between a vehicle and its surrounding vehicle(s) in wireless communication system to which the invention is applicable.

In reference to FIG. 1, the wireless communication system to which the invention may be applied can be composed of a vehicle 100, surrounding vehicles 110 to 130, a server 200 and a network 300.

However, the wireless communication system mentioned hereinafter includes at least one among those components shown in FIG. 1, but not limited thereto. In addition, only one vehicle, surrounding vehicles, one server and one network are shown respectively in FIG. 1. Alternatively, wireless communication systems to which the invention can be applied may include more than one vehicle, surrounding vehicle, server (e.g. relay server and client server), and network, wherein a connection can be established and data can be transmitted and received between each vehicle, surrounding vehicle, and server through different networks.

Meanwhile, the vehicle 100 according to one embodiment of the invention means an in-vehicle communication apparatus capable of transmitting and receiving communication signals or messages, inclusive of vehicle information, location information or multimedia data, to/from at least one external device or surrounding vehicle.

In addition, the vehicle 100 may be equipped with a display unit used to display the vehicle information, location information or multimedia data, and relevant OS (Operating System), program or application to operate the display unit may be installed.

At the same time, the vehicle 100 can transmit or receive data or signals to or from the surrounding vehicles 110 to 130 or the server 200.

As mentioned above, the vehicle 100 is an in-vehicle communication apparatus capable of transmitting and receiving communication signals or messages, to/from at least one external device or surrounding vehicle, and the in-vehicle communication apparatus may include any technical characteristics of exemplary apparatuses such as user device, mobile phone, terminal, MS (Mobile Station), MSS (Mobile Subscriber Station), SS (Subscriber Station), AMS (Advanced Mobile Station), WT (Wireless Terminal), MTC (Machine-Type Communication) apparatus, M2M (Machine-to-Machine) apparatus, and D2D (Device-to-Device) apparatus, as they are.

However, the abovementioned embodiments are just examples for explaining the invention; thus, a vehicle in the context of the invention should be construed as a concept to include all kinds of mobile apparatuses capable of performing data input/output, data transmission/reception, or data display, which have been already developed and commercialized or will be developed in the future, in addition to the abovementioned examples.

The server 200 means an object capable of transmitting and receiving data through the wireless communication network, including relay server and/or client server as mentioned before.

More specifically, the server 200 according to the invention may mean an apparatus capable of transmitting and receiving data or messages to/from the vehicle 100, the surrounding vehicles 110 to 130, etc.

Moreover, cloud server, IMS (IP Multimedia Subsystem) server, telephony application server, IM (Instant Messaging) server, MGCF (Media Gateway Control Function) server, MSG (Messaging Gateway) server, or CSCF (Call Session Control Function) server may be included as one embodiment of the server 200, and the server 200 may also be implemented as an apparatus referring to an object which can transmit and receive data, such as PC (Personal Computer), notebook computer, and tablet PC (Tablet Personal Computer).

On the other hand, the network 300 means a data communication network to transmit and receive data including, but not limited to, texts, digital images, and digital videos to/from the vehicle 100, surrounding vehicle 110 to 130 and the server 200.

For example, the network 300 can be an IP (Internet Protocol) network, providing service for transmitting and receiving large capacity data through IP, or an All-IP network, incorporating different types of IP networks.

Besides, the network 300 may be either of mobile communication network including wireless network, Wibro (Wireless Broadband) network, and mobile communication network including WCDMA, HSDPA (High Speed Downlink Packet Access) network and mobile communication network including LTE (Long Term Evolution) network, mobile communication network including LTE-A (LTE advanced), satellite communication network or Wi-Fi network. Alternatively, the network 300 may comprise a combination of at least one of the networks. The network 300 may be construed as a concept to include near field communication technology, covering BLE (Bluetooth Low Energy), RFID (Radio Frequency Identification), IrDA (Infrared Data Association), UWB (Ultra Wideband), ZigBee, and Z-wave.

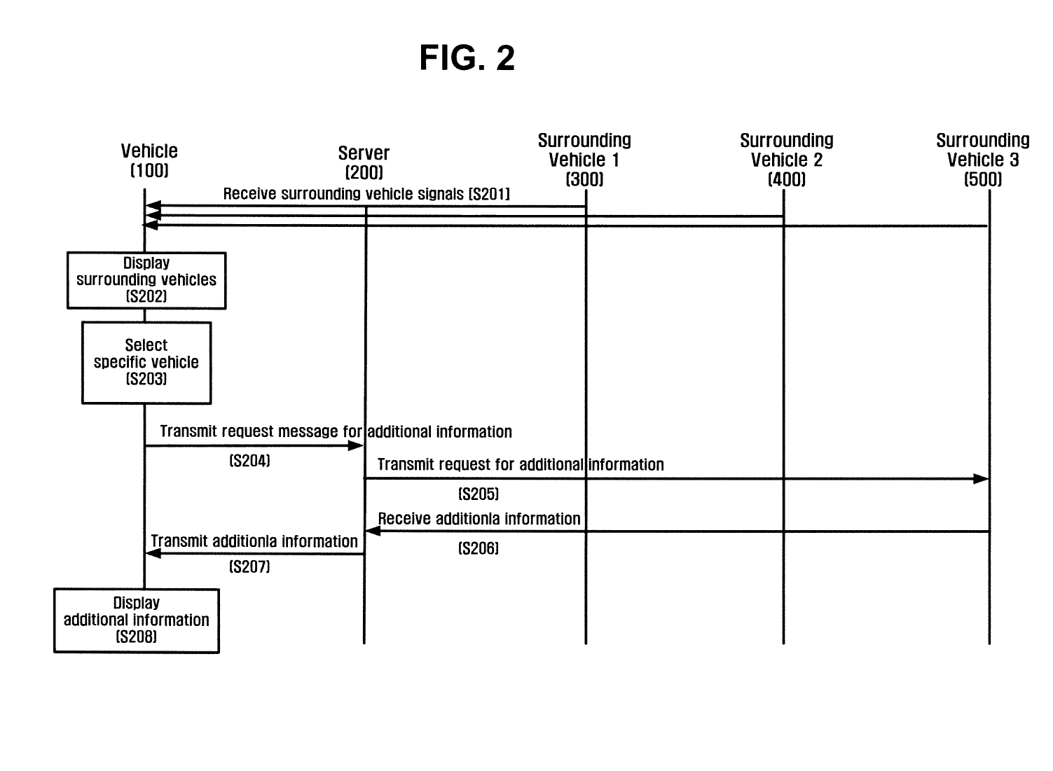

FIG. 2 is a diagram to shows a flowchart for a method with which an in-vehicle communication apparatus receives multimedia data of surrounding vehicle based on location in wireless communication system according to one embodiment of the invention.

In reference to FIG. 2, the wireless communication network system, in which a method, wherein the in-vehicle communication apparatus according to one embodiment of the invention receives multimedia data of the surrounding vehicles based on location, can be applied, may include the vehicle 100, the server 200, and the surrounding vehicles 300, 400, and 500, and further include additional servers and surrounding vehicles according to the implementation.

In addition, the wireless communication network system, in which a method, wherein the in-vehicle communication apparatus according to one embodiment of the invention receives multimedia data of the surrounding vehicles based on location, can be applied, includes at least one among those components shown in FIG. 2, but not limited thereto.

In reference to FIG. 2, the vehicle 100 can receive signals from the surrounding vehicles, including VID (Vehicle Identifier) of at least one surrounding vehicles, respectively from each of at least one surrounding vehicle 200, 300, and 400 or communication apparatus within the at least one surrounding vehicle. (S201)

At this moment, the signals from the surrounding vehicles can be received by beacon; thus, the vehicle 100 and each of at least one surrounding vehicle 300, 400, and 500 may be equipped with an apparatus capable of transmitting and receiving the beacon.

Furthermore, the abovementioned surrounding vehicles 200, 300, and 400 may indicate at least one vehicle located within a predetermined distance from the vehicle 100, and the distance may vary according to setting.

For example, the predetermined distance can be set to a distance within 10 meters from the vehicle 100. In addition to the method to set the distance in meter, the distance can be set in several units, such as centimeter, kilometer, yard, mile, or foot.

In the meantime, according to one embodiment of the invention, the signals of each surrounding vehicle, which the vehicle 100 receives from the surrounding vehicles 300, 400, and 500 in the step S201, may include VID (Vehicle Identifier) of the surrounding vehicles as described earlier. Alternatively, location information and vehicle information of each surrounding vehicle 300, 400, or 500 may be further included.

Here, The VID of the surrounding vehicles may include at least one out of VIN (Vehicle Identification Number), QR (Quick Response) code, text, and diagram representing the surrounding vehicle, and vehicle number(or car number) indicated on license plate of the surrounding vehicle.

Back to FIG. 1, the vehicle 100, which has received the surrounding vehicle signals from the surrounding vehicles 300, 400, and 500 in the step S201, can display at least one surrounding vehicle 300, 400, and 500 based on the received surrounding vehicle signals, respectively. (S202)

At this moment, the driver of the vehicle 100 can check each of at least one surrounding vehicle 300, 400, and 500 displayed in the step S202, and based on this, additionally select at least one specific vehicle, on which the driver wants to get more information, out of the surrounding vehicles 300, 400, and 500.

If the display unit displayed at least one surrounding vehicle 300, 400, and 500 for making a selection is provided in the form of touch screen, the driver can touch a specific vehicle on the touch screen to select it out of at least one surrounding vehicle. If the display unit is provided in the form of other than touch screen, the driver can select a specific vehicle via user input unit.

On the other hand, in case that a user selects a specific vehicle out of at least one surrounding vehicle 300, 400, and 500 displayed above, the vehicle 100 can transfer a message concerning a specific vehicle selected by the user to request additional information to the server 200 connected in advance, as shown in FIG. 1. (S204)

The message to request additional information may include the VID (Vehicle Identifier) of the selected specific vehicle, and the VID of the specific vehicle selected may be the VID included in the surrounding vehicle signals received from each of one ore more surrounding vehicles 300, 400, and 500 in the step S201.

In addition, the server 200 in the invention may already have VIN (Vehicle Identification Number) for the vehicle 100 and each of the surrounding vehicles 300, 400, and 500, QR (Quick Response) code, text, and diagram representing the surrounding vehicle, and vehicle number(or car number) indicated on license plate of the surrounding vehicle in its storage. This can be done by inputting the information in advance using a device or a smart device capable of communicating with the vehicle 100 and the surrounding vehicles 300, 400, and 500 or by directly inputting the information in advance in the server.

Furthermore, in case that the server 200 already knows VIN (Vehicle Identification Number) of a surrounding vehicle, QR code, text, and diagram representing the surrounding vehicle, and vehicle number(or car number) indicated on license plate of the surrounding vehicle according to the method, it is possible to communicate directly with the corresponding vehicle to transmit and receive data or signals.

Therefore, after receiving a message to request additional information from the vehicle 100 in the step S204, the server 200 can check a specific vehicle and transmit the request to ask for the additional information to the checked specific vehicle, using at least one out of VIN (Vehicle Identification Number) of at least one vehicle, QR (Quick Response) code, text, and diagram representing the surrounding vehicle, and vehicle number(or car number) indicated on license plate of the surrounding vehicle stored on the server, based on the VID (Vehicle Identifier) of the specific vehicle contained in the message to request additional information. (S 205 )

Hereinafter, more specific explanation will be given assuming that the abovementioned specific vehicle is the surrounding vehicle 3, 500, for convenience of explanation.

On the other hand, after transmitting the message to request additional information to the specific vehicle 500 in the step S205, the server 200 can receive the additional information from the specific vehicle 500 as the response for the request for additional information. (S 206 )

Here, the additional information may include the vehicle information and location information of the specific vehicle, and multimedia data generated by the in-vehicle communication apparatus of the selected specific vehicle.

Here, the location information may indicate the direction and distance of a gap, showing how far the location of the specific vehicle 500 away from the vehicle 100 or in which direction the specific vehicle 500 is located relative to the vehicle 100. According to one embodiment of the invention, it is possible to directly calculate the location information relative to the specific vehicle 500 based on the surrounding vehicle signals received by the vehicle 100 from the specific vehicle 500, unlike what is shown in FIG. 2. At this moment, the location information may be the information on a coordinate point on the latitude and longitude of the surrounding vehicle, calculated by using GPS.

In addition, the vehicle information may include information related to the specific vehicle 500. More specifically, driving direction, steering angle, vehicle speed, applied or unapplied state of the brake, and status information of the driver of the specific vehicle 500 may be included.

Moreover, the information on the abovementioned driving direction, steering angle, vehicle speed, and so on of the specific vehicle 500 may be expressed as in which direction the specific vehicle is currently driven, how much the steering angle is deviated relative to the zero (0) degree, how fast the vehicle runs in kilometers per hour or miles per hour, etc.

The multimedia data may include image information around the specific vehicle 500 taken by the specific vehicle, sound information around the specific vehicle 500 recorded by the specific vehicle, and any other data or signals which the specific vehicle 500 can provide.

On the other hand, after receiving the additional information from the specific vehicle 500 in the step S206 as the response for the request for additional information, the server 200 can transmit the additional information to the vehicle 100. (S207)

After receiving the additional information from the server 200, the vehicle 100 can display the received additional information. (S208) In addition, the display can receive and display the additional information by means of streaming method. Here, the streaming method means a technique to play multimedia data including images or sounds in real-time. The streaming method is advantageous in that playing time can be shortened and the memory capacity will not be largely affected.

Based on the method with which an in-vehicle communication apparatus receives multimedia data of surrounding vehicle based on location in wireless communication system, which is the invention, described by means of the steps S201 to S208, the driver of the vehicle 100 can obtain a preferable effect of exactly understanding the vehicle information and the location information of one or more surrounding vehicle, respectively, no matter how one or more surrounding vehicles are located around the vehicle 100 based on the current location.

Further, according to one embodiment of the invention, it is possible to request and receive the vehicle information, location information, and multimedia data of a specific vehicle located around the vehicle 100. In addition to the effect, the driver of the vehicle 100 can obtain another effect of enhancing the driving stability even more using the vehicle information and location information for at least one specific vehicle among at least one surrounding vehicle, and the multimedia data generated from the specific vehicle because the driver can check the vehicle information, location information, and multimedia data through the display unit of the vehicle 100.

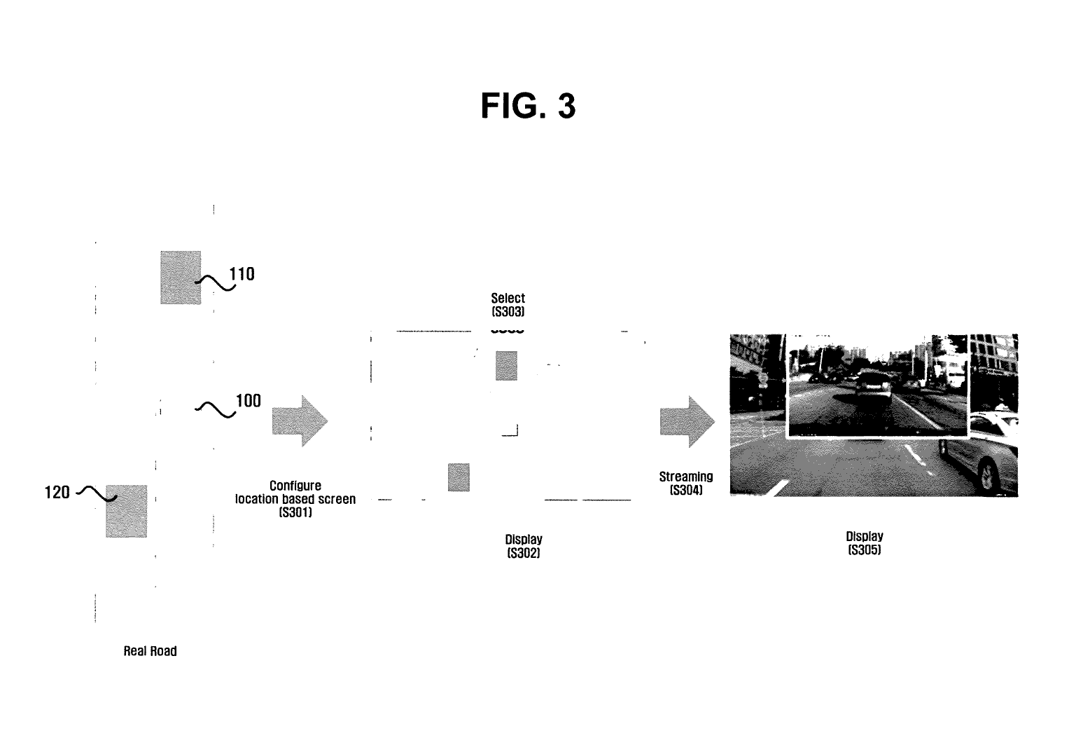

FIG. 3 is a diagram to describe a method with which the in-vehicle communication apparatus receives multimedia data of surrounding vehicle through a server in wireless communication system according to one embodiment of the invention.

In FIG. 3, any explanations identical to or overlapped with those for FIG. 2 may be contracted or omitted, on the premise that technological characteristics of the invention described in FIG. 2 can be incorporated and implemented in FIG. 3 completely.

In reference to FIG. 3, the wireless communication system, wherein a method with which the in-vehicle communication apparatus receives multimedia data of surrounding vehicle through a server according to one embodiment of the invention, can consist of the vehicle 100 and the surrounding vehicles 110 and 120. The system may include additional server(s) as shown in FIG. 2, although it is not disclosed in FIG. 3.

According to one embodiment of the invention, the vehicle 100 can receive surrounding vehicle signals including VIDs (Vehicle Identifier) of at least one surrounding vehicle respectively from each of at least one surrounding vehicle 110 and 120 (or communication apparatus(es) within at least one surrounding vehicle), according to the method as described in FIG. 2.

On the other hand, the vehicle 100 can configure a location based screen centered around the vehicle 100, representing each of the surrounding vehicles, based on the surrounding vehicle signals received, and then display the configured location based screen to the user of the vehicle 100 via the display unit in the vehicle 100. (S301 and S302)

At this moment, the driver of the vehicle 100 can check the vehicle information and the location information of each of at least one surrounding vehicle 110 and 120 displayed in the steps S301 and S302, and additionally select a specific vehicle 110, on which the driver wants to get more information, out of the at least one surrounding vehicle 110 and 500 based on this. (S303)

On the other hand, in case that a user selects a specific vehicle 110 out of the at least one surrounding vehicle 110 and 120 displayed above, the vehicle 100 can receive the additional information concerning the specific vehicle 110 selected by the user from the server according to the method described in FIG. 2.

In FIG. 2, it was explained that the vehicle 100 received the additional information on the specific vehicle 110 via the server; however, the vehicle can receive the additional information directly from the specific vehicle not through the server depending on implementation.

On the other hand, the server or the vehicle 100 having received the additional information from the specific vehicle 110 can display the received additional information. At this moment, the display unit may further display the additional information received by means of streaming method. (S304)

In the invention, the additional information may include the vehicle information and location information of the specific vehicle 110, and multimedia data generated by the in-vehicle communication apparatus of the selected specific vehicle 110. The multimedia data may include image information around the specific vehicle taken by the specific vehicle, sound information around the specific vehicle recorded by the specific vehicle,

Therefore, according to one embodiment of the invention, the user of the vehicle 100 can obtain preferable effects in that the user can directly check not only the vehicle information and the location information of the specific vehicle 110 located in the front of the vehicle 100 on a real road, but also the front image and/or sound of the specific vehicle 110, as shown in FIG. 3. (S305) This enables the user of the vehicle 100 to get more expanded visibility to further range than direct visible area or wider range, resulting in enhancing the driving stability even more.

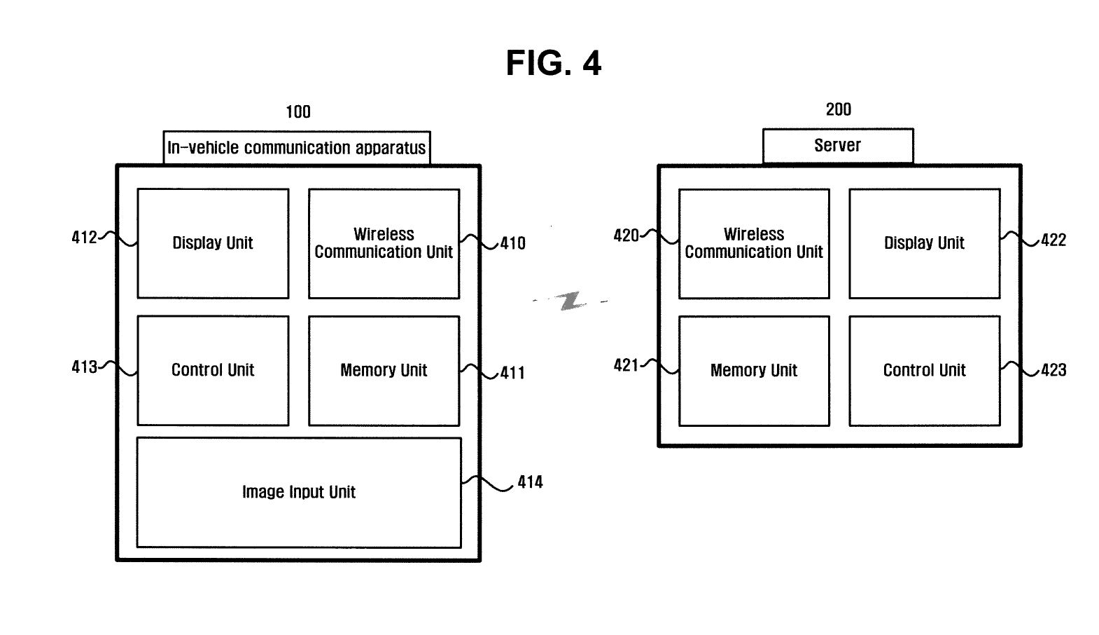

FIG. 4 is a block diagram to represent the components of the in-vehicle communication apparatus and the server according to one embodiment of the invention.

In reference to FIG. 4, in-vehicle communication apparatus 100 and server 200, wherein the invention can be applied to, are shown, and only one in-vehicle communication apparatus 100 and one server 200 are shown in FIG. 4. Alternatively, more than one in-vehicle communication apparatus and one server may be included.

The server 200 may consist of wireless communication unit 420 including transmission and reception units capable of storing data, memory unit 421, display unit 422, and control unit (or processor, 423).

However, the abovementioned embodiments are just examples for explaining the invention; thus, the server 200 may further include configurations other than that shown in FIG. 4. Alternatively, a configuration wherein some unit is omitted from the configuration shown in FIG. 4 may be implemented.

In addition, general process related to data communication with the in-vehicle communication apparatus 100, such as signal processing and layer processing of the server 200 is controlled by the memory unit 421 and the control unit 423, and a connection may be established among the memory unit 421, the wireless communication unit 420, and the control unit 423.

The wireless communication unit 420 incorporated into the server 200 may include transmission and reception units as mentioned above. Transmission and reception units may be configured to transmit and receive data and signals by means of wireless communication between the in-vehicle communication apparatus 100 and the server 200.

The control unit 423 may be configured in such a way that it is functionally connected with the transmission unit and the reception unit in the wireless communication unit, allowing the transmission unit and the reception unit to control the process of data or signal transmission/reception between the in-vehicle communication apparatus 100 and the server 200. In addition, the control unit 423 can conduct various processes for the data to be transmitted and transfer the data to the transmission unit, as well as conduct processes for the data received by the reception unit.

If necessary, the control unit 423 can store the information contained in the exchanged data into the memory unit 421. With this architecture, the server 200 can perform various types of embodiment methods of the invention as described in FIG. 1 to FIG. 3.

Meanwhile, the in-vehicle communication apparatus 100 in the invention may be integral apparatus to the vehicle, otherwise may be implemented as an individual apparatus that can be separated from the vehicle. In this specification, a vehicle may mean one containing the in-vehicle communication apparatus 100 as an integral component or an individual component for convenience of explanation.

The wireless communication unit 410 containing the transmission unit and the reception unit of the in-vehicle communication apparatus 100 is comprised to transmit and receive data or signals by mean of wireless communication with the server 200. In addition, the control unit 413 in the in-vehicle communication apparatus 100 may be configured in such a way that it is functionally connected with the transmission unit and the reception unit, allowing the transmission unit and the reception unit to control the process of data or signal transmission/reception to or from other devices including the server 200.

Furthermore, as described above, the in-vehicle communication apparatus 100 in the invention may include the display unit 412 to display surrounding vehicle signals or additional information received from surrounding vehicle or the server 200 inside or outside the in-vehicle communication apparatus 100.

The display unit 412 displays and outputs the information processed by the in-vehicle communication apparatus 100. For example, when the in-vehicle communication apparatus 100 receives surrounding vehicle information or additional information, the display unit 412 can display the received information using UI (User Interface) or GUI (Graphic User Interface). In addition, when images are included in the surrounding vehicle information or additional information, at least one image taken or received can be displayed separately or simultaneously along with UI and GUI.

In addition, the display unit 412 may include at least one out of liquid crystal display, thin film transistor-liquid crystal display, organic light-emitting diode, flexible display, and 3D display, wherein two or more display units may exist according to the implementation type. For example, external display unit and internal display unit can be equipped simultaneously in the in-vehicle communication apparatus 100.

An image input unit 414 may consist of a camera unit and an audio unit, which may be equipped inside or outside the in-vehicle communication apparatus 100.

The image input unit 414 can play a role to extract image and sound signals obtained from the ambient environment of the in-vehicle communication apparatus 100 and process the extracted signals, and can be connected with the wireless communication unit 410 and the control unit 413, allowing the collected image and sound signals to be transferred to at least one external device.

On the other hand, the control unit 413 can perform various processes for data or signals to be transferred and transfer the data or signals to the transmission unit, as well as process the data or signals received by the reception unit.

If necessary, the control unit 413 may also store the information contained in the exchanged data into the memory unit 411.

The control units 413 and 423 of the in-vehicle communication apparatus 100 and the server 200 can instruct the in-vehicle communication apparatus 100 and the server 200 to perform certain actions (e.g. control, adjustment, management, etc.), and each of the control units 413 and 423 may be connected with the memory units 411 and 421, which can store programs codes and data.

The memory units 411 and 421 can be connected to the control units 413 and 423, storing an operating system, an application, and general files.

The control units 413 and 423 of the invention may be called processors, controllers, microcontrollers, microprocessors, microcomputers, and so on. In addition, the control units 413 and 423 can be implemented by hardware, firmware, software, or a combination of them.

For an implementation by firmware or software, one embodiment of the invention may be implemented in a form of a module, a procedure, a function, etc. performing the functions or the operations described above. Software codes can be stored in the memory units 411 and 421 and run by the control units 413 and 423. The memory units may be located inside or outside the in-vehicle communication apparatus 100 and the server 200, and may exchange data with the control units 413 and 423 by various means already described.

On the other hand, the methods described above can be written in a form of program capable of being run on a computer, and implemented on a general-purpose digital computer to run the program using computer readable media. Furthermore, the structure of the data used in the methods described above can be recorded on the computer readable media via several means. The computer readable media storing executable computer codes to perform various methods of the invention include storage media such as magnetic storage media (e.g. ROMs, floppy disks, and hard disks) and optical readable media (e.g. CD-ROM and DVD).

A person skilled in the art related to embodiments of the claimed invention may be able to understand that the methods described above may be implemented in modified forms falling within the essential characteristics of the descriptions. Accordingly, the described methods should be considered in a descriptive viewpoint, instead of a restrictive viewpoint. The range of the invention is presented in the claims section, not in detailed description section for the invention, and all of the differences within the equivalent range to the claims should be construed as included in the range of the invention.

### INDUSTRIAL APPLICABILITY

The embodiments of the invention, which is the method and apparatus for receiving multimedia data of surrounding vehicle based on location in wireless communication system, can apply to various methods and apparatuses for receiving multimedia data.

### DESCRIPTION OF SYMBOLS

| | |
|---|---|
| 100: In-vehicle communication | 200: Server |
| apparatus | |
| 410: Wireless communication unit | 420: Wireless communication unit |
| 411: Memory unit | 421: Memory unit |
| 412: Display unit | 422: Display unit |
| 413: Control unit | 423: Control unit |
| 414: Image input unit | |

What is claimed is:

1. A Method for receiving multimedia data of at least one surrounding vehicle(s) on the basis of location by an in-vehicle communication apparatus of a vehicle in a wireless communication system, comprising the steps of:
receiving surrounding vehicle signal(s) including information on VID (Vehicle Identifier) of each of the at least one surrounding vehicle(s) from each in-vehicle communication apparatuses of the at least one surrounding vehicle(s);
displaying each of the at least one surrounding vehicle(s) on the basis of the received surrounding vehicle signal(s); and
if an user of the in-vehicle communication apparatus selects a specific vehicle of the at least one displayed surrounding vehicle(s), receiving additional information on the specific vehicle from a server and displaying the received additional information on the specific vehicle;
wherein the additional information includes at least one of vehicle information and location information of the specific vehicle, and the multimedia data generated by an in-vehicle communication apparatus of the selected specific vehicle.

2. The method of claim 1, wherein the surrounding vehicle(s) is at least one vehicle located within a predetermined distance from the vehicle.

3. The method of claim 1, wherein the location information of the specific vehicle comprises direction and distance of a gap determined based on the vehicle.

4. The method of claim 1, wherein the vehicle information of the specific vehicle includes driving direction, steering angle, vehicle speed, applied or unapplied state of the brake, and status information of the driver of the specific vehicle.

5. The Method of claim 1, wherein the information on VID includes at least one of VIN (Vehicle Identification Number) of the surrounding vehicle(s), QR (Quick Response) code, text, and diagram representing the surrounding vehicle(s), and vehicle number indicated on license plate of the surrounding vehicle(s).

6. The Method of claim 1, wherein the step of displaying the additional information, further comprising:
transmitting an additional information request message, generated by including a vehicle identification information of the selected specific vehicle, to the server; and
receiving the additional information, which the server received from the specific vehicle on the basis of the vehicle identification information in the additional information request message as a response to the additional information request message, from the server.

7. The Method of claim 1, wherein the multimedia data includes the real-time image information taken by the in-vehicle communication apparatus in the selected specific vehicle and the sound information recorded by the in-vehicle communication apparatus in the selected specific vehicle.

8. The Method of claim 1, wherein the step of receiving and displaying the additional information, comprising:
receiving the additional information by means of streaming method; and
displaying the received additional information.

9. The Method of claim 1, wherein the signals from the surrounding vehicle(s) are received by beacon.

10. An in-vehicle communication apparatus of a vehicle for receiving multimedia data of at least one surrounding vehicle(s) on the basis of location in wireless communication system, comprising the apparatus of:
a display unit;
a wireless communication unit including transmission unit and reception unit; and
a control unit configured to connect with the display unit and the wireless communication unit and to control the display unit and the wireless communication unit;
wherein the control unit configured to receive surrounding vehicle signal(s) including information on VID (Vehicle Identifier) of each of the at least one surrounding vehicle(s) via the wireless communication unit from each in-vehicle communication apparatuses of the at least one surrounding vehicle(s),
wherein the control unit configured to display each of the at least one surrounding vehicle(s) via the display unit on the basis of the received surrounding vehicle signal(s),
if an user of the in-vehicle communication apparatus selects a specific vehicle of the at least one displayed surrounding vehicle(s), wherein the control unit configured to receive additional information on the selected specific vehicle from the server via the wireless communication unit and to display the received additional information on the specific vehicle via the display unit, and
wherein the additional information includes at least one of vehicle information and location information of the specific vehicle, and the multimedia data generated by an in-vehicle communication apparatus in the selected specific vehicle.
